(19) United States
(12) Patent Application Publication
(10) Pub. No.: US 2026/0261026 A1
(43) Pub. Date: Sep. 3, 2026

(54) COATED DISC HAVING A COMMUNICATION WINDOW

(71) Applicant: SAINT-GOBAIN SEKURIT FRANCE, THOUROTTE (FR)

(72) Inventors: Li-Ya YEH, HERZOGENRATH (DE); Nadine HECKER, HERZOGENRATH (DE)

(21) Appl. No.: 19/159,897

(22) PCT Filed: Jan. 17, 2024
(86) PCT No.: PCT/EP2024/050987

§ 371 Date: Aug. 26, 2025

(30) Foreign Application Priority Data
Feb. 27, 2023 (EP) 23158735.3

(51) Int. Cl. H01P 1/08

(52) U.S. Cl. CPC H01P 1/08

(57) ABSTRACT

A coated pane having a communication window, includes a pane, a coating on a surface of the pane, wherein the coating has at least one communication region and a base region, wherein the coating has at least one dielectric layer in the communication region and at least the dielectric layer in the base region and an electrically conductive layer above the dielectric layer, and wherein the communication region has fewer layers than the base region and is free of electrically conductive layers, wherein the individual layers of the coating are thin layers.

The invention relates to a coated pane having a communication window, to a method for producing such a coated pane and to its use.

Panes with metallic or metal-containing layers are widely used in both building glazing and vehicle glazing. These metal-based coatings influence the transmittance, reflection and absorption behaviour of electromagnetic radiation. Electrically conductive coatings can be used to heat the pane.

The use of metal-containing coatings as sun protection coatings and the use as heat radiation reflecting layers (low-E layers) is known. A sun protection coating reflects a significant portion of the incoming solar radiation, especially in the infrared range, which leads to reduced heating of the interior in summer. The low-E layer reduces the emission of long-wave thermal radiation from a heated pane into the interior when the low-E layer is applied to the surface of a pane facing the interior. In winter, when the outside temperature is low, the heat of the interior is prevented from radiating to the outside environment. Such layers are known, for example, from WO2022248260A1, DE202021102267U1 and WO2022161770A1.

However, panes with metal-containing coatings also have disadvantages. For example, radiofrequency radiation is absorbed by many metal-containing coatings. This significantly impairs the functionality of many sensors, navigation, telecommunications or radio devices. To solve these problems, it is usually necessary to remove at least part of the metal-containing coating. In the example of electromagnetic radiation in the radio frequency range such as FM, AM, UHF, VHF, DAB, mobile telephony in the GSM 900, GSM 1800 and UMTS bands, satellite-based navigation (GPS) or microwave radiation, at least a net or grid-like decoating is necessary. The grid meshes must have a line spacing that is significantly smaller than the relevant wavelength of the desired electromagnetic radiation. For this purpose, the metal-containing coatings in the form of lines are removed using a suitable laser, for example. Since only small portions of the metal-containing coating need to be removed, the infrared radiation absorbing effect is largely preserved. Layers that are at least partially permeable to radiofrequency radiation are known, for example, from WO2004051869A2 and U.S. Pat. No. 6,730,389B2.

EP3034295A1, WO2014033007A1 and WO2012066324A1 disclose panes having a communication window in which the metal-containing coating is removed by means of laser beams. In this case, the coating is completely removed in regions intended for decoating in order to create a communication window. The decoating process is energy-consuming and time-consuming.

DE202021100791U1 discloses a glass pane which, as is typical for vehicle panes, has a black print in an edge region, wherein a functional coating of the glass pane is applied to the pane outside said edge region. Typical black prints are made of enamel with glass frits, which, when applied to glass, usually have thicknesses of well over 10 μm. Such thicknesses of black print are usually necessary to achieve sufficient opacity of the pane in the desired region.

The present invention is based on the object of providing a coated pane having a communication window which can be produced in a cost-effective, sustainable and efficient manner. The object is also to provide an improved method for producing a coated pane having a communication window. It should be possible to carry out the method in different ways and the method should allow the creation of a communication window of any shape and size.

The object is achieved by a coated pane according to independent claim 1 and by a method according to independent claim 10. Preferred embodiments are apparent from the dependent claims.

The pane coated according to the invention and having a communication window comprises a pane and a coating on a surface of the pane. The coating has at least one communication region and at least one base region. The coating has at least one dielectric layer in the communication region and at least the dielectric layer in the base region and an electrically conductive layer above the dielectric layer. The communication region has fewer layers, preferably at least one layer less, than the base region, and is free of electrically conductive layers. This means that there are no electrically conductive layers in the communication region of the coating.

The dielectric layer in the communication region and the base region is the same layer. The dielectric layer is preferably in direct contact with the pane, i.e. it is the first layer on the pane. Further layers can be arranged above the dielectric layer in the communication region and in the base region, wherein the additional layers arranged in the communication region and in the base region are preferably all arranged below the electrically conductive layer in the base region. In the base region, layers can also be arranged above the electrically conductive layer. Also, more than one electrically conductive layer, preferably 2, particularly preferably 3 electrically conductive layers, can be arranged In the base region. If further layers are arranged in the communication region in addition to the dielectric layer, the further layers are preferably arranged in the base region in exactly the same order without additional intermediate layers. In other words, the layers arranged in the communication region are preferably arranged in the same form and order in the base region, except that the base region has at least the electrically conductive layer above these layers. This has the advantage that the communication region can be created simply by removing the upper layers, including the electrically conductive layer, of the base region.

Within the context of the invention, the communication region of the pane means the region which can function as a kind of communication window. The pane is therefore more permeable to high-frequency radiation with a frequency of, for example, 1 to 3 GHz in the communications range than in the base range. The communication range therefore allows the reception of radiation, which is required, for example, for the proper use of sensors, navigation, telecommunications or radio devices. The at least one dielectric layer in the communication region does not reduce the permeability of the high-frequency radiation to a large extent. In order to create the communication window, the coating does not have to be completely stripped in any region. This is a great advantage of the invention.

Preferably, the coated pane is more permeable to radiation with a wavelength of greater than 1 μm, particularly preferably greater than 1.2 μm, in particular greater than 1.5 μm, in the communication region than in the base region.

Within the context of the invention, a dielectric layer is understood in particular to mean a layer made of a material with a degree of electrical conductivity (reciprocal of specific resistance) of less than 104 S/m. Electrically conductive layers, on the other hand, are in particular layers made of a material with a degree of electrical conductivity of greater than 104 S/m.

Additional dielectric layers can be arranged in the base region. As a result of the dielectric layers, for example aesthetic coatings with a specific colour can be realised or coatings with anti-reflective properties in the visible spectral range or with reflective properties in the ultraviolet spectral range (UV range) or in the infrared spectral range (IR range). Further dielectric layers can also be arranged in the base region and in the communication region, wherein these layers preferably have no or largely no reflective properties in the ultraviolet spectral range (UV range) or in the infrared spectral range (IR range). Particularly preferably, one, preferably two, particularly preferably three, further dielectric layers are arranged in the base region above the electrically conductive layer. The additional dielectric layers can influence the reflection properties, colour and transmittance of the pane. The desired properties can thus be adjusted via additional dielectric layers.

In a preferred embodiment of the invention, only the dielectric layer according to the invention and no further dielectric layer, in particular no further layers, is (are) arranged in the communication region of the coating. The communication region is preferably formed by removing all layers by means of laser beams, wherein all layers except the dielectric layer according to the invention have been removed. The communication region of the pane coated according to the invention is essentially just as suitable for use as a communication window as a completely decoated region of a generic pane.

The further dielectric layers can, for example, comprise layers with a high refractive index and layers with a low refractive index, which are arranged alternately, wherein the reflective or anti-reflective properties are caused by interference effects. The optically high-refractive layers have for example a refractive index of at least 1.8, preferably at least 2.0. The optically low-refractive dielectric layers have, for example, a refractive index of less than 1.8, preferably less than 1.6.

Common dielectric layers from which the dielectric layer and the additional dielectric layers, which may be present, are constructed are based, for example, on silicon nitride, silicon-metal mixed nitrides, such as silicon zirconium nitride, titanium oxide, aluminium nitride, aluminium oxide, tin oxide, zinc oxide, tin-zinc mixed oxide, zirconium nitride, zirconium oxide or silicon oxide. If a layer of the coating is formed on the basis of a material, this means within the context of the invention that the layer consists predominantly of the material, i.e. in a proportion of at least 50% by weight, preferably at least 70% by weight, particularly preferably at least 90% by weight. The layer may also contain in particular dopants and/or impurities, preferably in a proportion of at most 10% by weight. The oxides and nitrides mentioned can be stoichiometric, substoichiometric or superstoichiometric with regard to the oxygen or nitrogen content.

Additional electrically conductive layers can also be arranged in the base region. The electrically conductive layer and any further electrically conductive layers that may be present are preferably formed on the basis of a metal, for example silver, or on the basis of a transparent conductive oxide (TCO, transparent conductive oxide), such as indium tin oxide (ITO, indium tin oxide). If a plurality of electrically conductive layers are present, adjacent conductive layers are preferably separated from one another by at least one dielectric layer. The electrically conductive layers are in particular functional layers which provide the coating with a function. For example, the electrically conductive layers can be IR-reflective in order to provide the coating with an IR-reflective function. The electrically conductive layers can also have emissivity-reducing properties. Likewise, the electrically conductive layers can provide the coating with a heating function when the coating is electrically contacted to pass a heating current through it.

Preferably, the communication region is formed by removing the topmost layer or layer sequences of the coating, so that the layer or layer sequences missing in the communication region compared to the base region of the coating is the topmost layer or layer sequence of the coating in the base region. If only a single layer is removed, that layer is the electrically conductive layer and therefore also the topmost layer. If a number of layers are removed (layer sequence), all layers to be removed are adjacent to each other and contain the topmost layer (and therefore form the topmost layer sequence). All layers to be removed later are therefore located above all remaining layers. The terms “topmost layer (sequence)” and “above” refer to the order of the layers starting from the pane: the topmost layer is the layer with the greatest distance to the pane surface and a layer is arranged above another layer if it has a greater distance to the pane surface. Accordingly, a second layer arranged below a first layer is a layer that has a smaller distance from the pane surface than the first layer. “Below” or “above” a layer does not necessarily mean that there must be direct spatial contact between the layers. For example, it is possible that a second layer is arranged above a first layer, but that further layers are also arranged between the second and first layer.

The coating is preferably transparent to visible radiation (380 nm to 780 nm) in both the base region and the communication region, so that it is possible to see through it. This applies in particular if the pane is also transparent and the article is intended as a window pane or part of such a window.

In a preferred embodiment of the invention, the communication region extends over the pane in the form of a grid when viewed from above. The shape of a grid means that the communication region extends in a grid-like manner over the pane. The communication region is preferably the region that represents the grid lines. The regions arranged between the grid lines of the communication region are preferably base regions. In particular, the communication region and the base regions extend over the entire coated surface of the pane. The grid-like shape of the communication region is preferably produced by ablation using laser beams. The grid-like communication region forms, for example, a pane structured with meshes and appears slightly brighter on the real pane than the surrounding coating (the base regions), in particular in grazing light or in reflection.

The communication region or regions together extend preferably over less than 20%, particularly preferably over less than 15%, and in particular over less than 10%, of the surface of the pane. The base region or regions preferably extend over at least 60%, particularly preferably at least 80%, in particular at least 90% of the surface of the pane. Particularly preferably, the communication region and the base region (alternatively also several communication regions and/or several base regions) together extend over the entire surface of the pane, particularly preferably with the exception of a circumferential linear edge region of the pane, which runs along and adjacent to the edges of the pane. Such edge decoating is particularly useful when the pane is part of a laminated pane and the coating needs to be protected from external influences.

According to the invention, the individual layers, i.e. dielectric layers and/or electrically conductive layers, of the coating are thin layers, which are understood to be layers with a thickness of less than one micrometer. They are deposited flat as layer stacks on top of each other. The layer thickness of the individual layers is preferably from 10 nm to 200 nm, the total thickness of the coating is for example from 50 nm to 1000 nm. Methods for measuring the thickness of thin layers are known to a person skilled in the art. The thickness of the individual layers can be determined using common methods for determining the layer thickness of thin layers, for example spectroscopic reflectometry, confocal microscopy, white light interferometry or ellipsometry. These methods enable non-destructive measurement, with corresponding measuring equipment being commercially available. Ellipsometers are commercially available, for example from Sentech. White light interferometry, profilometry, for example confocal profilometry, or ellipsometry are preferably used.

In a preferred embodiment of the invention, the at least one electrically conductive layer of the base region has a layer thickness of greater than 10 nm, preferably greater than 15 nm and particularly preferably greater than 20 nm. With such layer thicknesses, there is a good emissivity-reducing effect. The solar radiation-reflecting effect is also improved with layer thicknesses above 10 nm. With such layer thickness, in particular, the electrically conductive layer is based upon a transparent conductive oxide (TCO)—for example, indium tin oxide (ITO).

The shape of the communication region(s) can be chosen arbitrarily, as can the shape of the base region or base regions. This makes it possible to create designs of any kind.

There may be a single, contiguous base region in which a single communication region or several communication regions are formed like islands. Each communication region is completely surrounded by the base region. The at least one communication region can, for example, have the shape of a two-dimensional geometric figure. If there is more than one communication region, the communication regions can have the same shape or different shapes. The communication regions can be distributed in the form of a regular pattern or irregularly.

However, other arrangements of communication region(s) and base region(s) can also be chosen. For example, a striped pattern or a chequerboard pattern can be displayed. Irregular patterns are also possible.

The pane is preferably made of transparent glass, in particular of soda lime glass. However, it can also be produced from other glass (for example borosilicate glass, quartz glass, aluminosilicate glass) or transparent plastics (for example polymethyl methacrylate or polycarbonate). The pane furthermore has a peripheral edge. The thickness of the pane can vary widely. Preferably, panes having a thickness in the range from 0.8 mm to 5 mm, preferably from 1.4 mm to 2.5 mm, are used, for example those with the standard thicknesses of 1.6 mm or 2.1 mm. The pane can be non-tempered, partially tempered or tempered. The prestressing can be a thermal or chemical prestressing.

The pane can have any three-dimensional shape. Preferably, the pane has no shadow zone, thereby allowing efficient coating by cathodic sputtering. The pane is preferably planar or slightly or markedly curved in one or more spatial directions. The pane is preferably flat, but in principle can also be cylindrical or spherically curved. It is also possible for the coating according to the invention to be applied to a flat pane and for the pane according to the invention to be subsequently bent.

According to the invention, one of the surfaces (main faces) of the pane is provided with the coating. In principle, it is also possible for both surfaces of the pane to be provided with the coating.

The coated pane according to the invention can also be a component of a laminated pane. The coated pane is, for example, the outer pane or the inner pane of a laminated pane, but preferably the inner pane. The term inner pane refers to the pane of the laminated pane which is intended to be positioned closer to an interior than the other pane(s) of the laminated pane. The outer pane refers to the pane of the laminated pane which is intended to be positioned closer to the external environment than the other pane(s) of the laminated pane. The inner pane and the outer pane are preferably connected to each other via a thermoplastic intermediate layer.

The coating is preferably applied over the entire surface of the pane so that the entire surface is covered with the coating. The differences in the base region and in the communication region can be achieved, for example, by removing individual layers of the surface in certain regions, for example by laser ablation. In principle, however, it is also conceivable that the differences in the communication region and in the base region are achieved by masked and unmasked regions. In other words, for example the dielectric layer is applied over the entire surface of the pane, the regions intended as communication regions are then masked and the other layers are then applied, wherein the regions intended as communication regions are then unmasked again. However, removing individual layers is clearly preferable to this variant, as it is much more efficient and cost-effective.

In an advantageous embodiment, the coating is deposited on the pane surface by vapour deposition—for example, by chemical vapour deposition (CVD), plasma-enhanced chemical vapour deposition (PECVD), or atomic layer deposition (ALD). Physical vapour deposition (PVD), for example evaporation deposition, is particularly preferred, cathode sputtering (“sputtering”) and in particular magnetic field-assisted cathode sputtering (“magnetron sputtering”) are very particularly preferred.

In an advantageous embodiment, the communication region is formed by removing at least the electrically conductive layer by means of laser beams after the coating has been applied to the pane. During laser processing, at least the electrically conductive layer and all layers lying thereabove are preferably removed from the communication region, while at least one dielectric layer remains in the communication region. The communication region is therefore obtainable by removing at least the electrically conductive layer and any layers that may be arranged above the electrically conductive layer by means of laser beams. Preferably, all layers except for a dielectric layer in the communication region are removed using laser beams. The formation of the communication region by removing layers using laser beams is an efficient and cost-effective method. Since not all layers have to be removed, a shorter processing time is required in contrast to panes that are typically decoated using laser beams. A pane partially decoated using laser beams can be visually distinguished from other manufacturing processes. Partial decoating using mechanical processes cannot be carried out with the same level of precision and is therefore clearly distinguishable from production using laser beams. The formation of the communication region and base region by means of masking and unmasking processes leads to very homogeneous layers which, due to the manufacturing process, only contain the applied layers. However, in case of partial decoating using laser radiation, insignificant residues of removed layers may remain, which measurably influences the optical properties of the pane. Decoating thus results in fewer homogeneous layers than in masking and unmasking processes, which means that the panes can be clearly distinguished from one another.

The invention further extends to a method for manufacturing a coated pane. The method is preferably carried out in the order specified.

(A) In a first step, a pane is provided.

(B) In a second step, in the following order, at least one dielectric layer and one electrically conductive layer are arranged as a coating on a surface of the pane.

(C) In a third step, at least the electrically conductive layer is removed in a communication region of the coating, wherein at least the dielectric layer remains in the communication region and the electrically conductive layer is not removed in at least one base region of the coating. Preferably, no layer is removed in the base region.

In the second step (B), further layers apart from electrically conductive layers, preferably further dielectric layers, can be arranged after or before the arrangement of the dielectric layer and before the arrangement of the electrically conductive layer. After the electrically conductive layer, further layers, both further electrically conductive layers and dielectric layers, can also be arranged, wherein in the third step (C) at least all electrically conductive layers are removed in the communication region.

Preferably, all applied layers except for the dielectric layer are removed in the communication region. This means that only one dielectric layer remains in the communication region of the pane, with all other layers being removed. In that case, the pane in the communication region is particularly permeable to high-frequency radiation.

In a particularly preferred embodiment of the invention, the dielectric layer is the layer closest to the pane. This means that the dielectric layer is preferably applied directly to the surface of the pane, without any additional layers being arranged between the dielectric layer and the pane.

In a particularly preferred embodiment of the invention, at least the electrically conductive layer, preferably all layers except for the dielectric layer, in the communication region of the pane are removed by means of laser radiation. The laser radiation is preferably moved over the at least one communication region (once or several times), wherein at least the electrically conductive layer is removed by ablation (laser ablation). The speed of movement of the laser radiation is preferably from 10 mm/s to 100 m/s, particularly preferably 100 mm/s to 50 m/s, very particularly preferably from 1 m/s to 25 m/s, in particular 3 m/s to 10 m/s.

With a fixed laser and a fixed pane, the laser radiation can be moved over the at least one communication region by a laser scanner, wherein the laser radiation is suitably moved by a system of movable mirrors. Alternatively, however, it is also possible to move the laser itself while the pane is stationary or to move the pane while the laser is stationary.

The coated surface of the pane after the second method step can face the laser. If the pane is (largely) transparent to the laser radiation (especially in the case of a glass pane), the coated surface can alternatively face away from the laser and the laser radiation can be directed through the pane onto the coating. In both cases, the laser radiation is preferably focused on the surface of the pane with the coating. The extent of the laser spots on the coating (diameter) is preferably from 25 μm to 250 μm, particularly preferably from 40 μm to 180 μm.

Laser radiation in the UV range, the visible range or the IR range of the electromagnetic spectrum is preferably used. The wavelength of the laser radiation is preferably from 200 nm to 2000 nm, particularly preferably from 250 nm to 1100 nm, for example from 355 nm to 1064 nm. Particularly good results are achieved thereby. For example, solid-state lasers can be used (e.g. Nd:YAG lasers or Yb:YAG lasers), which can be frequency doubled, frequency tripled or frequency doubled twice, as required. Such lasers are widely used industrially, relatively inexpensive and efficient. Alternatively, diode lasers, excimer lasers, gas lasers or dye lasers can also be used.

The laser is preferably operated in shelled mode. The pulse length of the laser is preferably in the femtosecond or nanosecond range. The pulse length is preferably no more than 1 ns, particularly preferably no more than 10 ps. The pulse length is very particularly preferably from 200 fs to 10 ps, particularly from 500 fs to 1 ps. Particularly good results are achieved thereby. Such short pulses minimise the thermal stress in the laser processing environment, making it possible to process thin layers and even heat-sensitive materials. The repetition frequency of the laser pulses is preferably from 10 KHz to 1000 kHz, particularly preferably from 50 KHz to 400 kHz. The pulse energy is preferably from 200 nJ to 500 μJ, particularly preferably from 250 nJ to 250 μJ, very particularly preferably from 150 μJ to 250 μJ.

The output power of the laser is preferably from 10 W to 200 W, preferably from 40 W to 150 W.

The laser radiation used can be adapted to the coating to be processed in order to achieve effective ablation of at least the electrically conductive layer, and possibly also further layers, in the communication region. This is achieved in particular by selecting the wavelength, the laser power, the pulse energy and the pulse length. All of these variables have an impact and can be selected accordingly. In addition, the effectiveness of ablation can also be adjusted by suitably selecting the speed of movement of laser radiation and the frequency of movement of laser radiation.

As an alternative to method steps (B) and (C), the pane can also first be coated with at least one dielectric layer in the communication region and in the base region on one surface and then the communication region can be masked, for example by means of cover films. The surface of the pane is then coated with at least the electrically conductive layer, wherein the masking prevents the pane from being coated with the at least electrically conductive layer in the communication region. The pane is coated in the base region with the at least electrically conductive layer. In the subsequent method step, the masking is removed from the coated pane.

The invention also comprises using the coated pane in the vehicle or architecture sector (in particular as a window pane of a vehicle, a building or an interior or as a component of such a window pane, or as a facade panel of a building), in furniture or other furnishing articles.

The invention is explained in more detail with reference to a drawing and exemplary embodiments. The drawing is a schematic representation and is not true to scale. The drawing does not limit the invention in any way. In the drawings:

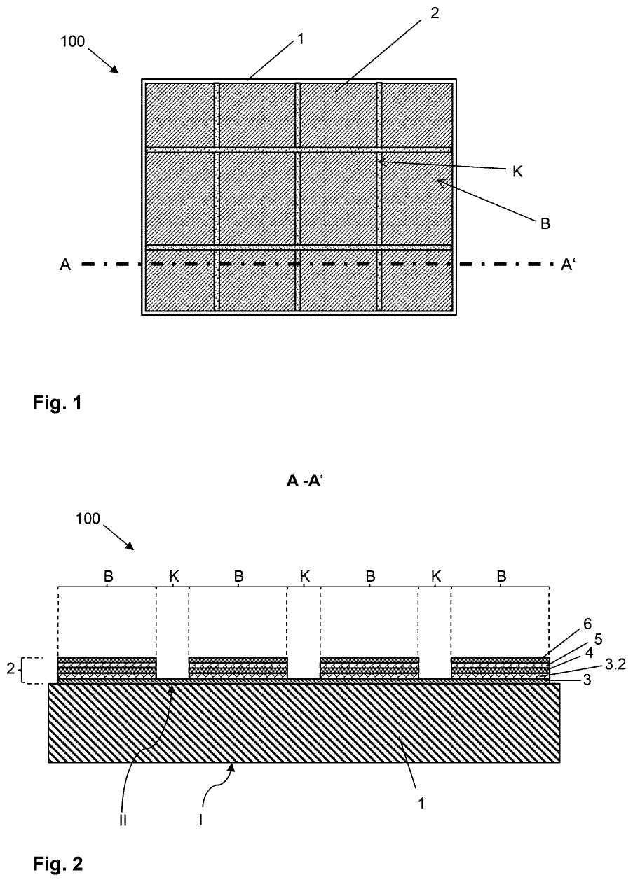

FIG. 1 is a top view of an embodiment of the coated pane according to the invention;

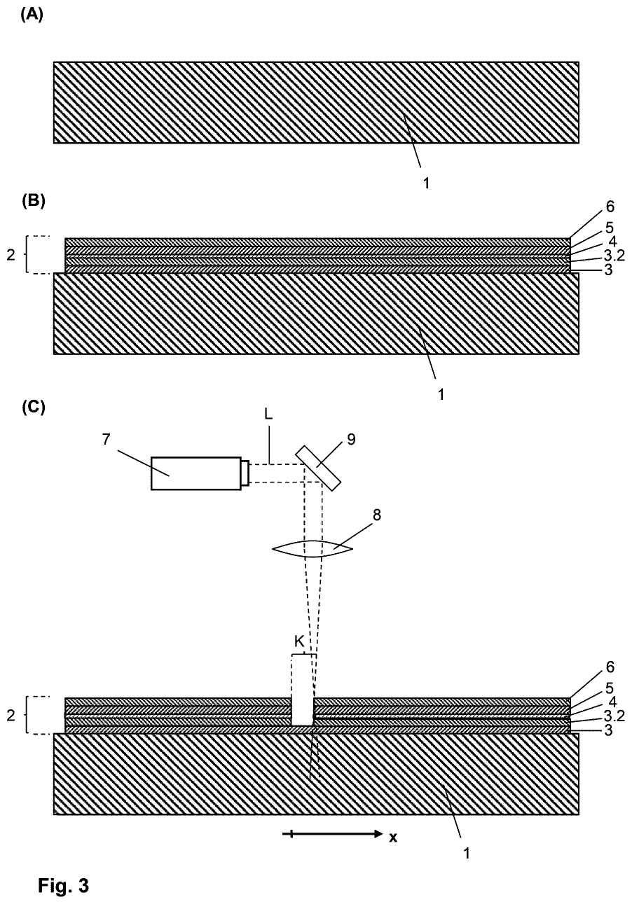

FIG. 2 is a cross-section along A-A′ through the pane of FIG. 1;

FIG. 3 is a cross-section through the pane of FIGS. 1 and 2 during its production with an embodiment of the method according to the invention;

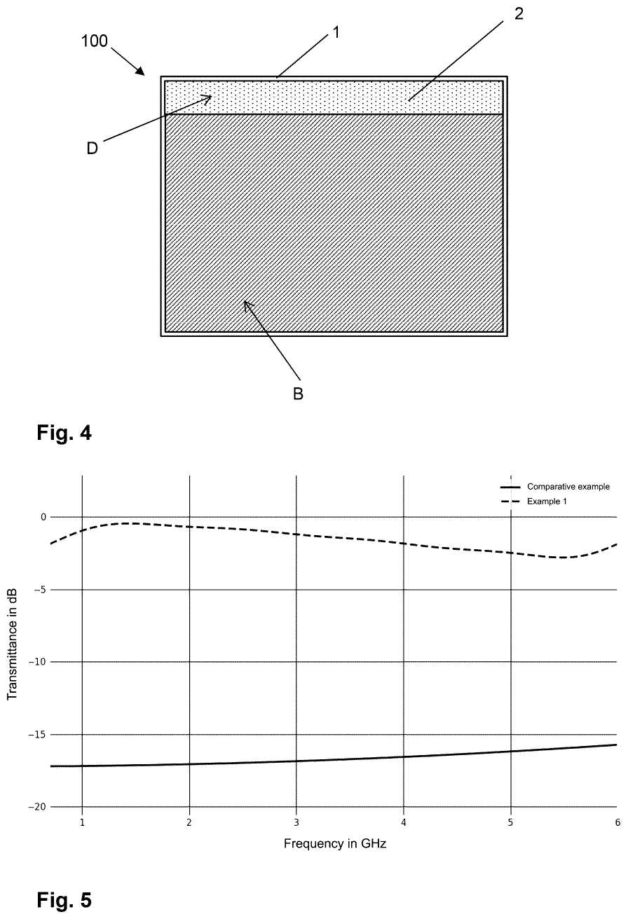

FIG. 4 is a top view of a further embodiment of the pane according to the invention; and

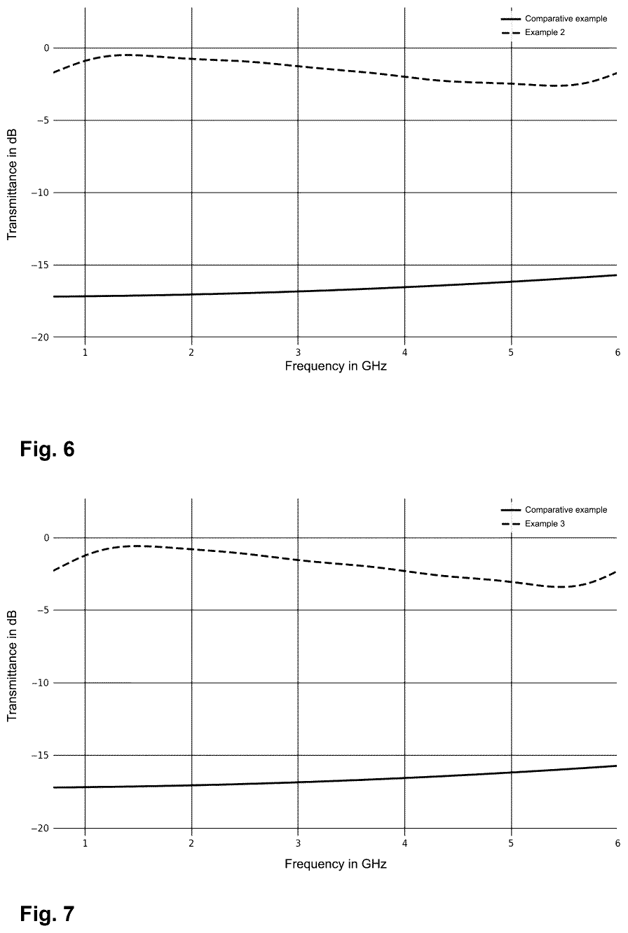

FIG. 5-7 show attenuation as a function of the radiation frequency shown in diagrams of the inventive examples 1 to 3 each with a comparative example.

FIG. 1 and FIG. 2 each show a detail of an exemplary coated pane 100 according to the invention. It is a pane 1, for example made of soda-lime glass, which is coated with a coating 2 on a surface II.

The pane 1 has, for example, a thickness of 2.1 mm. The pane 1 is intended to be used as the inner pane of a laminated pane and to be connected to an outer pane via a thermoplastic intermediate layer. The laminated pane is provided as a roof pane of a motor vehicle, for example. The pane 1 has two main faces which are intended for viewing through the glass pane, namely a first surface I and a second surface II, as well as a circumferential side edge face extending therebetween.

The coating 2 has several base regions B which are arranged within a grid-like structure of a communication region K. In plan view of the pane 100, the communication region K is in the form of stripes from an upper edge of the pane 1 to the lower edge of the pane 1 and from one side edge to the other side edge of the pane 1. The side edges connect the upper edge and the lower edge, so that the side edges, the upper edge and the lower edge make up the entire circumferential edge of the pane 1. The stripes of the communication region K form a grid shape in the overall view. The communication region or regions K and the base region or regions B can basically be designed as desired. The communication region K does not have to be arranged in the form of a regular pattern, as shown by way of example in the figure.

The coating 2 is designed as a stack of thin layers and is designed differently in the base regions B from in the communication region K. In the base regions B, the coating 2 has a total of five layers: a first dielectric layer 3, a second dielectric layer 3.2, an electrically conductive layer 4, a third dielectric layer 5 and a fourth dielectric layer 6, which are arranged in the specified order starting from the second surface II of the pane 1. However, the electrically conductive layer 4, the second dielectric layer 3.2, the third dielectric layer 5 and the fourth dielectric layer 6 are missing in the communication region K, so that the coating 2 in the communication region K is formed only from the first dielectric layer 3. An exemplary layer sequence of the coating 2 with materials and layer thicknesses is summarised in Table 1.

TABLE 1

| | | Layer thickness | | | |
|---|---|---|---|---|---|
| Reference | | Base | | Communication | |
| signs | Material | region B | | region K | |
| 6 | SiO₂ | 50 | nm | — | |
| 5 | Si₃N₄ | 9 | nm | — | |
| 4 | ITO | 72 | nm | — | |
| 3.2 | SiO₂ | 17 | nm | — | |
| 3 | Si₃N₄ | 30 | nm | 30 | nm |
| 1 | Soda-lime glass | 2.1 | mm | 2.1 | mm |

Due to the alternating sequence of optically high-refractive layers 2.1, 2.3 based on silicon nitride (Si₃N₄) and optically low-refractive layers 2.2, 2.4 based on silicon oxide (SiO₂), the coating 2 has reflection-reducing properties as a result of interference effects. In addition, the coating 2 in the base regions B has a solar radiation-reflecting effect due to the electrically conductive layer 4 based on indium tin oxide (ITO).

Since the coating 2 has a significant influence on the appearance of the glass pane, the base regions B and the communication region K differ optically from one another, in particular by a different degree of reflection and a different colour (reflection colour). The observer can therefore easily distinguish the communication region K from the base regions B, at least using suitable optical measuring devices.

The design shown here is to be understood as an example only. The coated pane 100 according to the invention can basically have any type of coating 2 as long as it has an influence on the optical properties of the article. The coating 2 can, for example, also be a sun protection coating with at least one silver layer with reflective properties in the near IR range or an emissivity-reducing coating (low-E coating) with an ITO layer with reflective properties in the mid-IR range (in particular in the range of thermal radiation of the pane 1).

The number of layers in the base regions B and the communication region K is also only exemplary. Alternatively, it would be possible, for example, that in the communication region K, compared to the base region B, only the electrically conductive layer 4, the third dielectric layer 5 and the fourth dielectric layer 6 are missing.

FIG. 3 shows cross sections through the coated pane 100 of FIGS. 1 and 2 in three method steps of the method according to the invention for its production. First, the pane 1 is provided (FIG. 3A). The coating 2 is then applied on the second surface II of the pane 1 (FIG. 3B). For this purpose, the layers 3, 3.2, 4, 5, 6 are deposited one after the other on the second surface II, for example by means of magnetic-field-assisted cathode sputtering I. Then, the topmost four layers 3.2, 4, 5, 6 are removed in the communication region K by means of the radiation L of a laser 7. For this purpose, the radiation L is focused onto the coating 2 by means of a focusing element 8, for example a lens or an objective. The radiation L is then moved along a direction of movement x over the entire communication region K by means of a laser scanning system which comprises at least one (typically at least two) movable, in particular tiltable mirrors 9. The layers 3.2, 4, 5, 6 are removed by laser ablation (FIG. 3C).

The radiation L has for example a wavelength in the visible spectral range. The laser 7 is for example a pulsed Yb:YAG laser with an emission wavelength of 1030 nm.

FIG. 4 shows a plan view of a further embodiment of an article according to the invention. The communication region K is arranged here in a single, continuous section of the pane 1. The communication region K extends in a strip shape from one side edge to the other side edge of the pane 1 and is arranged closer to the upper edge of the pane 1 than to the lower edge of the pane 1. In this embodiment there is only one base region B. The base region B extends from one side edge to the other side edge of the pane 1 and is arranged closer to the lower edge of the pane 1 than to the upper edge of the pane 1. The base region B extends, for example, over 80% of the second surface II of the pane 1, wherein the communication region K extends over the remaining second surface II of the pane 1 less a non-coated circumferential edge region of the pane 1.

FIGS. 5 to 7 show radiation attenuation in decibels as a function of the frequency of the radiation for panes 100 coated according to the invention, each with a comparative example and without communication region K. The pane of the comparative example has a coating over the entire surface of the pane like the coating 2 present in the base regions B of FIGS. 1 and 2. The panes according to the invention are decoated in the same manner as the pane 100 shown in FIGS. 1 and 2.

A special transmittance measuring setup was used to measure attenuation. Two antennas suitable for transmitting and receiving radiation with a frequency of more than 1 GHz were provided. A first antenna was installed inside an absorber chamber and was used to receive radiation. The second antenna was mounted outside the absorber chamber, wherein the first antenna and the second antenna are mounted opposite each other and separated by a metal wall having an opening, i.e. a hole. The metal wall is a component of the absorber chamber. The absorber chamber thus has an opening exactly between the two antennas. For the measurement, panes according to Examples 1 to 3 were applied to the opening, with the coated surface of the panes always facing the metal wall. The second antenna emitted radiation over the region shown in FIGS. 5 to 7 and the first antenna received the emitted radiation; therefore, it was possible to determine the attenuation of the radiation by the panes of Examples 1 to 3. The determined attenuation is related to a reference value (zero axis in FIGS. 5 to 7) where the opening of the metal wall is free, i.e. there is only air between the antennas. The determination of attenuation was carried out according to ASTM F3057-16. Attenuation with a pane according to the comparison example was simulated. The simulation was performed using CST Studio Suite 2023.

The panes of Examples 1 to 3 were produced by coating and subsequent partial decoating in the communication region. Decoating was carried out using laser radiation as shown in FIG. 4. Examples 1 to 3 differ from each other only in the speed of movement of the laser. The differences are shown in Table 2:

TABLE 2

| | Speed of | Wavelength of | | Pulse |
|---|---|---|---|---|
| | movement | laser beams | Pulse length | energy |
| Example 1 | 3 m/s | 1064 nm | 10 ps | 250 μJ |
| Example 2 | 12 m/s | 1064 nm | 10 ps | 250 μJ |
| Example 3 | 15 m/s | 1064 nm | 10 ps | 250 μJ |

Attenuation is clearly lower for all Examples 1 to 3 than for the comparison example in which no partial decoating took place in the communication region. The remaining dielectric layer in the communication region of Examples 1 to 3 does not have a significant influence on the attenuation of radiation. Decoating can therefore take place at high laser movement speeds, since complete decoating is not necessary. This is a great advantage.

### LIST OF REFERENCE SIGNS

1 Pane
2 Coating
3 Layer of coating 2/first dielectric layer
3.2 Layer of coating 2/second dielectric layer
4 Layer of coating 2/electrically conductive layer
5 Layer of coating 2/third dielectric layer
6 Layer of coating 2/fourth dielectric layer
7 Laser
8 Focusing element
9 Tiltable mirror
100 Coated pane
K Communication region of coating 2
B Base region of coating 2
L Radiation of the laser 7
I First surface of the pane 1
II Second surface of the pane 1
X Direction of movement of the radiation L
A-A′ Cutting line

1. A coated pane having a communication window, comprising:
a pane,
a coating on a surface of the pane,
wherein the coating has at least one communication region and a base region,
wherein the coating has at least one dielectric layer in the communication region and at least the dielectric layer in the base region and an electrically conductive layer above the dielectric layer, and
wherein the communication region has fewer layers than the base region and is free of electrically conductive layers, wherein the individual layers of the coating are thin layers.

2. The coated pane according to claim 1, wherein the communication region extends over the pane in the form of a grid in a top view of the pane.

3. The coated pane according to claim 1, wherein the communication region extends over less than 20% of the surface of the pane.

4. The coated pane according to claim 1, wherein the electrically conductive layer has a layer thickness of greater than 10 nm in the base region.

5. The coated pane according to claim 1, wherein the communication region is obtainable by removing at least the electrically conductive layer by means of laser beams.

6. The coated pane according to claim 1, wherein the electrically conductive layer is formed on the basis of a metal, a metal alloy or a transparent, electrically conductive oxide.

7. The coated pane according to claim 1, wherein the communication region is more permeable to radiation having a wavelength greater than 1 μm than the base region.

8. The coated pane according to claim 1, wherein the base region has one further dielectric layer above the electrically conductive layer.

9. The coated pane according to claim 1, wherein the communication region is free of further dielectric layers.

10. A method for producing a coated pane, comprising:
providing a pane,
arranging, in the following order, at least one dielectric layer and one electrically conductive layer as a coating on a surface of the pane, and
removing at least the electrically conductive layer in a communication region of the coating, wherein at least the dielectric layer remains in the communication region and the electrically conductive layer is not removed in at least one base region of the coating.

11. The method according to claim 10, wherein the dielectric layer is applied directly to the pane so that the dielectric layer is the layer closest to the pane.

12. The method according to claim 10, wherein at least the electrically conductive layer is removed by a laser radiation in the communication region.

13. The method according to claim 12, wherein the laser radiation has a wavelength in the UV range, in the visible range or in the IR range.

14. The method according to claim 12, wherein the laser radiation is pulsed with pulse lengths in the femtosecond or nanosecond range.

15. A method comprising providing a coated pane according to claim 1 in a vehicle or architecture sector.

16. The coated pane according to claim 3, wherein the communication region extends over less than 15% of the surface of the pane.

17. The coated pane according to claim 4, wherein the electrically conductive layer has a layer thickness of greater than 15 nm in the base region.

18. The coated pane according to claim 8, wherein the base region has two further dielectric layers above the electrically conductive layer.

19. The method according to claim 12, wherein all layers except for the dielectric layer are removed by the laser radiation in the communication region.

20. The method according to claim 13, wherein the wavelength is in a range from 200 nm to 2000 nm.
